(19) United States
(12) Patent Application Publication
(10) Pub. No.: US 2009/0310447 A1
(43) Pub. Date: Dec. 17, 2009

(54) OBJECTIVE LENS ACTUATOR

(75) Inventor: Yoshihiro IKAWA, Osaka (JP)

Correspondence Address: HAMRE, SCHUMANN, MUELLER & LARSON P.C., P.O. BOX 2902-0902, MINNEAPOLIS, MN, 55402, US

(73) Assignee: Panasonic Corporation, Osaka (JP)

(21) Appl. No.: 12/482,905

(22) Filed: Jun. 11, 2009

(30) Foreign Application Priority Data
Jun. 12, 2008 (JP) 2008-153821
Jun. 4, 2009 (JP) 2009-134559

(51) Int. Cl. G11B 7/00

(52) U.S. Cl. 369/44.15; G9B/7

(57) ABSTRACT

An objective lens actuator is provided in which an objective lens is hardly affected by a higher vibration mode and a gain crossover frequency can be increased even when the objective lens is disposed at the end of a lens holder. Between the optical axis of an objective lens 11 and an end 12a on a lens holder 12 for holding the objective lens 11, a notch 20 is provided as a discontinuous portion having discontinuous stiffness in parallel with a focusing direction. With this configuration, the position of the node of a tertiary vibration mode exhibiting unstable control characteristics can be brought close to the position of the objective lens 11 and the influence of a higher vibration mode can be avoided.

### FIELD OF THE INVENTION

The present invention relates to an objective lens actuator and particularly relates to an objective lens actuator used for an optical pickup device and the like of an optical disk drive for irradiating a disk-like recording medium with a light spot to record and reproduce information optically.

### BACKGROUND OF THE INVENTION

An optical pickup device is used for an optical disk drive that irradiates a disk-like recording medium (referred to as a disk) such as a CD, a DVD, a Blu-ray disc, and an HD-DVD disc with a light beam spot to record and reproduce information made up of pit strings on the recording surface of the disk. Further, an optical pickup device has an objective lens actuator for driving an objective lens used for forming a light beam spot.

In recent years, optical disk drives have realized high-speed recording/reproduction by increasing the number of revolutions of disks with an increase in data transfer rate. Thus it is necessary to cause objective lenses to perform faster tracking in response to surface deflection and decentering that occur on disks at high speeds, and objective lens actuators used for optical pickup devices have been required to have the property of being able to control a high frequency domain.

To be specific, by setting a gain crossover frequency at a higher frequency in the control system of an optical pickup device, an objective lens can be caused to track pit strings on a disk at a high speed. However, by setting a high gain crossover frequency, stability is lost by the influence of a higher vibration mode of a lens holder. Thus objective lens actuators have been required to have the property of being less susceptible to the influence of a higher vibration mode.

In an objective lens actuator of the prior art, an objective lens generally is disposed at the center of a lens holder to be less affected by the influence of a higher vibration mode. Further, the lens holder is made of a material having high stiffness and a low specific gravity, and the shape of the lens holder is designed so as to increase the stiffness, so that a higher vibration mode is shifted to a frequency higher than a gain crossover frequency in the objective lens actuator of the prior art.

### DISCLOSURE OF THE INVENTION

However, as has been described as a prior art technique in the specification of Japanese Patent Laid-Open No. 2003-6894, even when the influence of a higher vibration mode is suppressed by increasing the geometrical moment of inertia of the shape of a lens holder to secure stiffness, a material is increased in thickness and the overall mass increases, so that the influence of a higher vibration mode cannot be reduced effectively.

In the objective lens actuator of Japanese Patent Laid-Open No. 2003-6894 and an objective lens actuator described in Japanese Patent Laid-Open No. 2007-149277, a weight is added as an additional member to a lens holder via an adhesive having low stiffness. A dynamic damper is provided for the lens holder, so that a higher vibration mode is reduced.

In the objective lens actuators of the prior art in Japanese Patent Laid-Open No. 2003-6894 and Japanese Patent Laid-Open No. 2007-149277, it is always necessary to add a weight to constitute a dynamic damper. Thus the mass of a moving part increases and sensitivity characteristics have to be sacrificed, which interferes with high-speed recording/reproduction.

Further, in order to obtain stable characteristics for the dynamic damper, it is necessary to apply stably an adhesive that has low stiffness and is used for obtaining damper characteristics, and attach a weight in a stable state, thereby increasing the number of assembling steps and cost.

By placing an objective lens at the center of the lens holder, the influence of a higher vibration mode is reduced. However, in an optical pickup device for a low profile of a notebook computer and the like considerably restricted in the height dimension, it is difficult to place the objective lens at the center of the lens holder and thus it is generally necessary to dispose the objective lens at the end of the lens holder.

In the objective lens actuator in which the objective lens is disposed at the end of the lens holder, it is more difficult to respond to a higher vibration mode than in the case where the objective lens is disposed at the center of the lens holder, and it is difficult to raise a gain crossover frequency because a plurality of higher order vibration modes are present.

The present invention has been devised to solve the foregoing problem. An object of the present invention is to provide an objective lens actuator in which an objective lens hardly is affected by a higher vibration mode and a gain crossover frequency can be raised without adding a weight as an additional member, even when the objective lens is disposed at the end of a lens holder in the objective lens actuator.

In other words, an object of the present invention is to provide a low-profile objective lens actuator suitable for achieving high-speed recording/reproduction.

In order to solve the problem, the present invention is an objective lens actuator including: an objective lens for focusing a light beam on a disk; a lens holder for holding the objective lens; a fixed part; a plurality of wires each having one end fixed to the fixed part and the other end fixed to the lens holder to support the lens holder with elasticity; and a magnetic circuit having magnets and coils, the magnetic circuit being configured such that the magnets are disposed on one of the fixed part and the lens holder and the coils are disposed on the other of the fixed part and the lens holder, and the magnetic circuit being able to drive the lens holder in a focusing direction and a tracking direction. The lens holder has an end on an extension line from a driving point for driving the lens holder to the optical axis of the objective lens, and the lens holder includes a discontinuous portion on the side of the end on the lens holder relative to the optical axis of the objective lens. The discontinuous portion has discontinuous stiffness in parallel with the focusing direction.

The lens holder of the present invention has an optical axis disposed at one of the node of a tertiary vibration mode of a vibration caused by a thrust force and a point near the node when the thrust force is applied at the driving point in the focusing direction.

With this configuration, the discontinuous portion having discontinuous stiffness in parallel with the focusing direction is included on the side of the end of the lens holder relative to the optical axis of the objective lens, so that the optical axis of the lens holder can be disposed at one of the node of the tertiary vibration mode and a point near the node. In other words, the node position of the tertiary vibration mode, which is an unstable mode, can be brought close to the position of the objective lens while hardly changing a secondary vibration mode, which is a stable mode of higher vibration modes. As a result, it is possible to obtain an objective lens actuator that can avoid the influence of higher vibration modes and keep a stable condition in terms of control.

Further, the lens holder of the present invention has a rib of discontinuous thickness in the focusing direction from the optical axis of the objective lens to the end and thus stiffness is made discontinuous in parallel with the focusing direction. For example, the lens holder has a rib of continuously changing thickness in the focusing direction from the optical axis of the objective lens to the end, the rib being cut partially at a point between the optical axis and the end, and thus stiffness is made discontinuous in parallel with the focusing direction.

Moreover, according to the present invention, the objective lens and the lens holder are fixed with a fixing agent having a stiffness sufficiently lower than the stiffness of the lens holder. With this configuration, vibrations from the lens holder hardly are transmitted to the objective lens. Thus by fixing the lens holder and the objective lens with an adhesive having low stiffness, a vibration system can be separated from the objective lens, thereby increasing the design freedom for the lens holder.

According to the present invention, it is possible to reduce the influence of the higher vibration modes and increase a gain crossover frequency to a high frequency. Thus by using the objective lens actuator of the present invention for an optical pickup device and an optical disk drive, it is possible to record and reproduce information stably at high speeds.

### BRIEF DESCRIPTION OF THE DRAWINGS

FIG. 1 is a perspective view showing an optical disk drive including an objective lens actuator according to an embodiment of the present invention;

FIG. 2 is a perspective view showing an optical pickup device including the objective lens actuator;

FIG. 3 is a perspective view showing the objective lens actuator;

FIG. 4 is an exploded perspective view showing the objective lens actuator;

FIG. 5 is a partial enlarged perspective view of a lens holder of the objective lens actuator;

FIG. 6 is an explanatory drawing showing the relationship between the cross section of the lens holder and higher vibration modes;

FIG. 7 is a Bode diagram showing frequency characteristics in a focusing direction; and

FIG. 8 is a Nyquist diagram showing frequency characteristics in the focusing direction.

### DESCRIPTION OF THE EMBODIMENT

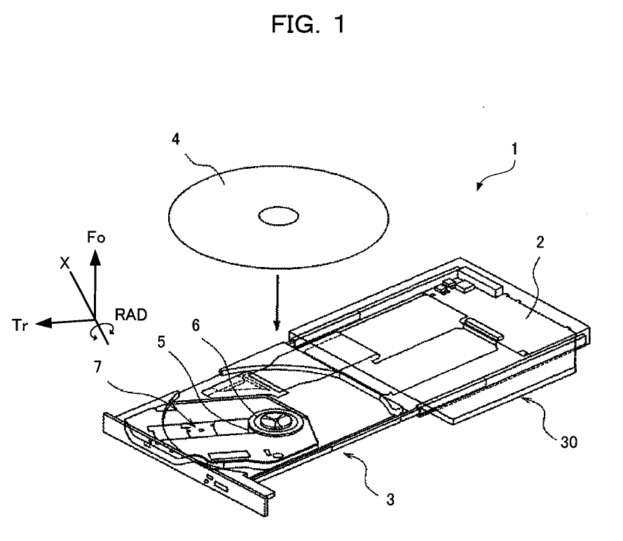

The present embodiment will be described below with reference to the accompanying drawings. FIG. 1 is a perspective view showing an optical disk drive including an objective lens actuator according to the present embodiment.

As shown in FIG. 1, an optical disk drive 1 is made up of a body case 30 that includes a control circuit board 2 for performing various kinds of control and a traverse unit 3 that can extend and retract from the body case 30.

The traverse unit 3 includes a spindle motor 5 for rotationally driving a disk (optical disk) 4, which is a disk-like recording medium, and an optical pickup device 7 for irradiating the disk 4 with a light beam spot to optically record and reproduce information. The disk 4 can be rotated while being chucked on a turntable 6 provided on the spindle motor 5. In the traverse unit 3, the optical pickup device 7 is disposed so as to move in a tracking direction which is the radial direction of the disk 4, that is, in the direction of arrow Tr.

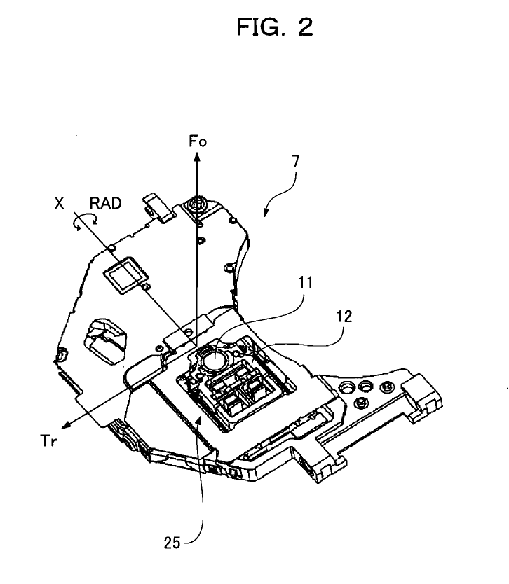

In FIG. 1, arrow Fo indicates a focusing direction for focus control on an objective lens 11 (see FIGS. 2 to 5) provided on the optical pickup device 7. Further, in FIGS. 1, 2 and 3, arrow RAD around the X axis perpendicular to the arrow Fo direction and the arrow Tr direction is a radial tilting direction, which is the rotation control direction of the objective lens 11 provided on the optical pickup device 7.

The optical pickup device 7 of the optical disk drive 1 irradiates the disk 4 with a light spot through the objective lens 11 and controls the position of the objective lens 11 in the focusing direction, the tracking direction, and the radial tilting direction based on a control signal of the control circuit board 2 when information is recorded or reproduced from the disk 4.

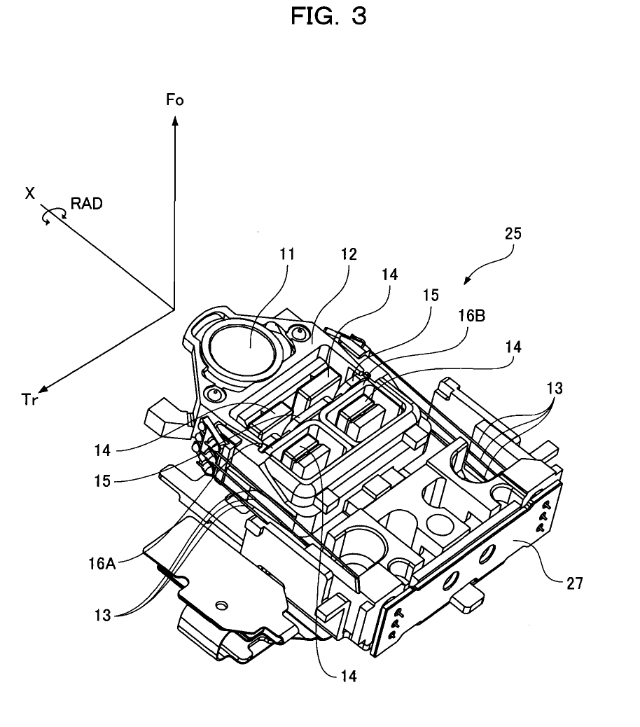

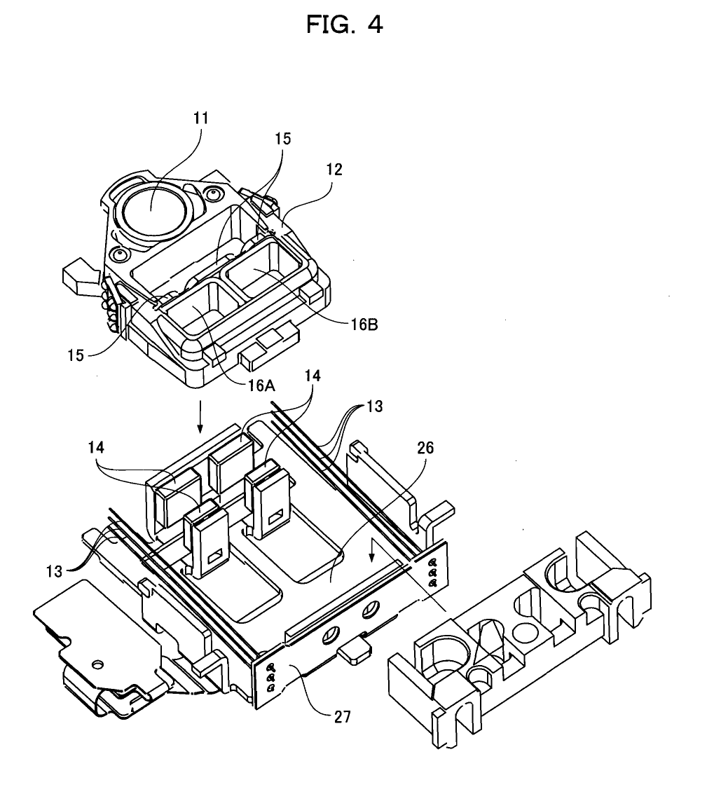

FIG. 2 is a perspective view showing the optical pickup device 7 of the optical disk drive 1. FIG. 3 is a perspective view showing an objective lens actuator 25 according to the present embodiment. FIG. 4 is an exploded perspective view showing the objective lens actuator 25. As shown in FIGS. 2 to 4, the objective lens 11 is held by a lens holder 12, and the lens holder 12 is supported with elasticity by a plurality of wires 13 (six wires in the present embodiment) each having one end fixed to a fixed part made up of a fixed base (fixed yoke) 26, a fixed substrate 27 or the like.

To the lens holder 12, tracking coils 15 and focusing coils 16A and 16B are attached. The tracking coils 15 and the focusing coils 16A and 16B are subjected to edge line processing so as to be energized through the wires 13. As shown in FIGS. 3 and 4, a plurality of magnets 14 are attached to the fixed base 26 and the lens holder 12 is disposed so that the tracking coils 15 or the focusing coils 16A and 16B face the magnets 14. The magnets 14, the tracking coils 15, and the focusing coils 16A and 16B constitute a magnetic circuit, and the tracking coils 15 and the focusing coils 16A and 16B are fed with magnetic fluxes from the magnets 14. In other words, the lens holder 12 is supported so as to be moved in the focusing direction, the tracking direction, and the radial tilting direction and so as to be driven in the focusing direction, the tracking direction, and the radial tilting direction by the magnetic circuit. When current is applied to the focusing coil 16A and the focusing coil 16B in the same direction, the objective lens 11 is driven with the lens holder 12 in the focusing direction. When the current is applied in opposite directions, the objective lens 11 is rotationally driven in the radial tilting direction.

The overall lens holder 12 is substantially shaped like a tongue and the objective lens 11 is mounted on a circular opening provided at the end of the lens holder 12. In other words, the objective lens 11 is disposed close to the end of the lens holder 12 such that the optical pickup device is usable for a low profile of a notebook computer and the like that have considerable restriction in the height dimension.

As has been discussed, the objective lens actuator 25 of the present embodiment includes the objective lens 11 for focusing a light beam on the disk 4, the lens holder 12 for holding the objective lens 11, the fixed part for supporting the lens holder 12 with elasticity via the plurality of wires 13, and the magnetic circuit having the magnets 14 and the tracking coils 15 and the focusing coils 16A and 16B. The magnets 14 are attached to the fixed part side and the tracking coils 15 and the focusing coils 16A and 16B are attached to the lens holder 12. The magnetic circuit can drive the lens holder 12 and the objective lens 11 in the focusing direction and the tracking direction.

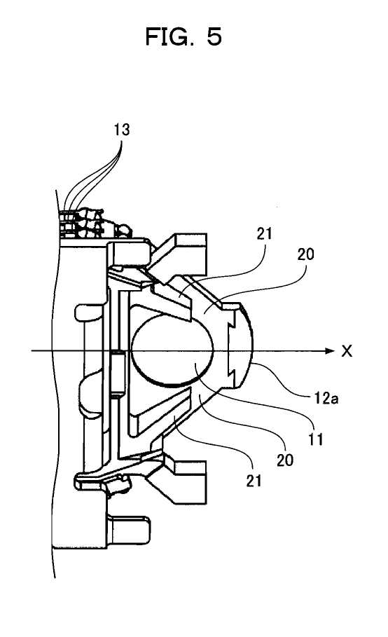

Referring to FIGS. 5 to 8, the lens holder 12 of the objective lens actuator 25 specifically will be described below.

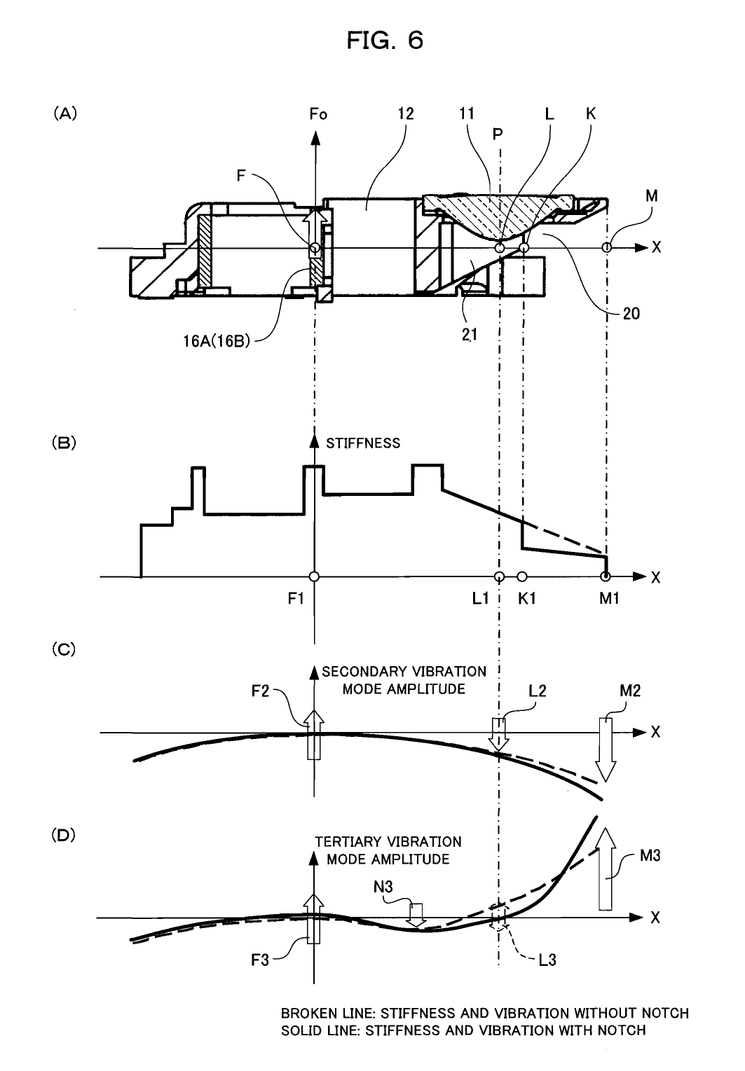

FIG. 5 is a partial enlarged perspective view of the lens holder and is also a perspective view showing the bottom of an end 12a of the lens holder 12 for holding the objective lens 11. An area (A) shown in FIG. 6 indicates the cross section of a moving part (supported by the fixed part via the wires 13) including the objective lens 11 and the lens holder 12. In the area (A) shown in FIG. 6, P represents the optical axis of the objective lens 11 and F represents a driving point for driving the lens holder 12 by means of the focusing coils 16A and 16B of the magnetic circuit. As shown in FIG. 5 and the area (A) shown in FIG. 6, the lens holder 12 has the end 12a on an extension line from the driving point F for driving the lens holder 12 using the magnetic circuit to the optical axis P of the objective lens 11. Further, the lens holder 12 has a rib 21 formed so as to extend from a portion around the holding portion of the objective lens 11 to the end 12a. The rib 21 reinforces the holding portion of the objective lens 11 on the lens holder 12 to increase stiffness. Between a position corresponding to the center of the objective lens 11 and the end 12a, that is, between the optical axis P of the objective lens 11 and the end 12a on the lens holder 12, a notch 20 serving as a discontinuous portion is provided and the rib 21 is formed just partway between the optical axis P and the end 12a. In other words, the rib 21 is not formed continuously to the end 12a and the discontinuous portion of the rib 21 is formed by the notch 20.

Generally, the stiffness of the lens holder is at least somewhat increased in a design method of the prior art and the foregoing configuration seems unreasonable. However, the discontinuous portion formed by the notch 20 can avoid the influence of a higher vibration mode causing unstable control characteristics. This point will be specifically described below.

FIG. 6 is an explanatory drawing showing the relationship between the cross section of the lens holder 12 and higher vibration modes. As has been discussed, the area (A) shown in FIG. 6 indicates the cross section of the moving part (supported by the fixed part via the wires 13) including the objective lens 11 and the lens holder 12. On the driving point F of the focusing coils 16A and 16B, a thrust force (driving force) is obtained in the focusing direction Fo. The following will examine higher vibration modes at positions disposed in the direction of arrow X, that is, at point L corresponding to the optical axis P passing through the center of the objective lens 11, point K corresponding to the notch 20, and point M corresponding to the end 12a of the lens holder 12. An area (B) shown in FIG. 6 schematically shows a geometrical moment of inertia, which corresponds to stiffness, according to the area (A) shown in FIG. 6. In the area (B) shown in FIG. 6, point F, point L, point K, and point M in the area (A) of FIG. 6 correspond to point F1, point L1, point K1, and point M1, respectively.

Between point L1 corresponding to the optical axis P of the objective lens 11 and point M1 corresponding to the end 12a of the lens holder 12, point K1 (the starting point of the formation of the notch 20) and point M1 are disposed, which correspond to the notch 20 serving as the discontinuous portion. The stiffness in the focusing direction Fo is reduced from point K1 to point M1 by the notch 20, so that the stiffness is made discontinuous. When the notch 20 is not provided, the stiffness smoothly declines from point K1 to point M1 as indicated by a broken line.

As has been discussed, in the objective lens actuator 25 of the present embodiment, the lens holder 12 has the end 12a on an extension line from the driving point F for driving by the magnetic circuit to the optical axis P of the objective lens 11, and the lens holder 12 includes the discontinuous portion, which has discontinuous stiffness in parallel with the focusing direction, between the optical axis of the objective lens 11 and the end 12a on the lens holder 12.

The vibration of the lens holder 12 that has the stiffness shown in the area (B) of FIG. 6 has eigenmode(s), and the native mode has a higher vibration mode called a secondary vibration mode or a tertiary vibration mode. The secondary vibration mode is indicated by an area (C) shown in FIG. 6, and the tertiary vibration mode is indicated by an area (D) shown in FIG. 6. In the area (C) shown in FIG. 6, arrow F2 indicates the driving direction on driving point F and arrow L2 and arrow M2 respectively indicate a displacement of point L corresponding to the optical axis P (center) of the objective lens 11 and a displacement of point M corresponding to the end 12a of the lens holder 12. In the secondary vibration mode, the deformation is entirely curved (shaped like an arc). The higher the vibration mode, the higher the frequency. In a primary vibration mode as the lowest mode, the lens holder 12 laterally moves through the wires 13 while keeping the attitude (the lens holder 12 makes a so-called translational motion).

In the tertiary vibration mode, a deformation is entirely S-shaped. The area (D) shown in FIG. 6 indicates the state of the deformation. In the area (D) shown in FIG. 6, arrow F3 indicates the driving direction on driving point F, arrow L3 indicates a displacement of point L corresponding to the optical axis P of the objective lens 11, and arrow M3 indicates a displacement of point M corresponding to the end 12a of the lens holder 12. Point L corresponding to the optical axis P of the objective lens 11 or a point near the optical axis P of the objective lens 11 serves as a vibration node and deformation hardly occurs on these points. In the tertiary vibration mode, a deformation occurs according to an order as indicated by arrow N3. In the absence of the notch 20 serving as the discontinuous portion, the tertiary vibration mode changes as indicated by a broken line. In this case, a displacement appears as indicated by arrow L3.

In other words, the objective lens actuator 25 of the present embodiment is considerably different from the objective lens actuator of the prior art in that the notch 20 provided as the discontinuous portion on the lens holder 12 controls the S-shaped deformation and the amplitude of the tertiary vibration mode of higher vibration modes is substantially suppressed as indicated by arrow L3 by a vibration on point L corresponding to the position of the optical axis of the objective lens 11. In other words, the objective lens actuator 25 sets the optical axis of the lens holder 12 at one of the node of the tertiary vibration mode and a point near the node to suppress the amplitude of the tertiary vibration mode. Moreover, in the objective lens actuator 25, the thickness of the rib 21 is made discontinuous by the notch 20. Further, in the objective lens actuator 25, the shape of the rib 21 with a continuously changing thickness is partially cut by the notch 20, so that the rib 21 has discontinuous stiffness.

As has been discussed, in the objective lens actuator 25 of the present embodiment, when a thrust force is applied on driving point F in the focusing direction, the optical axis of the lens holder 12 is disposed at one of the node of the tertiary vibration mode of a vibration caused by the thrust force and a point near the node.

Further, in the objective lens actuator 25 of the present embodiment, the lens holder 12 has the rib 21 of discontinuous thickness in the focusing direction from the optical axis of the objective lens 11 to the end 12a, so that stiffness is made discontinuous in parallel with the focusing direction.

Moreover, on the lens holder 12, by partially cutting the shape of the rib 21 having a continuously changing thickness in the focusing direction from the optical axis of the objective lens 11 to the end 12a, stiffness is made discontinuous in parallel with the focusing direction.

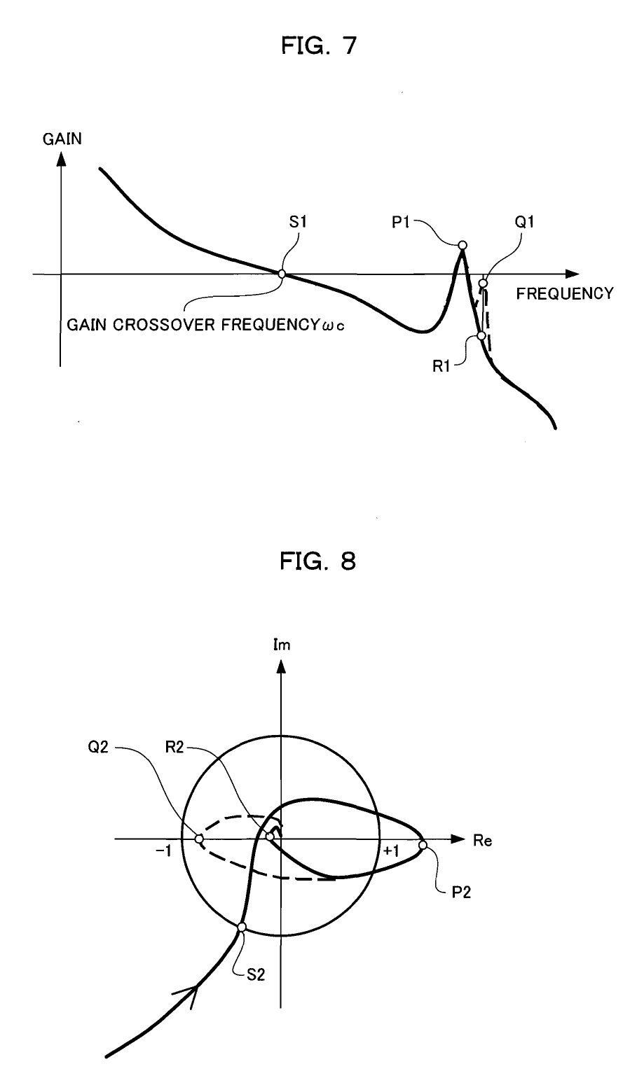

Referring to FIGS. 7 and 8, the following will describe the relationship between the control characteristics of the objective lens actuator 25 of the present embodiment and a higher vibration mode. FIGS. 7 and 8 are respectively a Bode diagram and a Nyquist diagram that show frequency characteristics in the focusing direction.

In FIG. 7, the vertical axis represents a gain of a focusing control system and the horizontal axis represents a frequency. At a gain crossover frequency ωc, the gain is 0 dB and crosses the horizontal axis at point S1. After that, the gain decreases but peaks at point P1 in the secondary vibration mode of the lens holder 12. At point R1, the tertiary vibration mode is present but a portion corresponding to the optical axis P of the objective lens 11 is disposed at (or near) the vibration node, so that there is no optical influence and the gain does not reach the peak. If the lens holder 12 does not include the notch 20 serving as the discontinuous portion, the gain is affected by the tertiary vibration mode and reaches the peak of point Q1 as indicated by a broken line.

FIG. 8 shows the Nyquist diagram in which the horizontal axis represents a real number and the vertical axis represents an imaginary number, and FIG. 8 is a plot of the Bode diagram of FIG. 7. Point S1, point P1, point Q1, and point R1 of FIG. 7 correspond to point S2, point P2, point Q2, and point R2 of FIG. 8, respectively. Point S2 is an intersection with a circle having a radius of 1, which indicates a one-time gain. At point P2, at least one-time gain is obtained but is plotted on the right half of the plane under stable conditions. At point R2, the gain is sufficiently small and oscillation conditions are not satisfied.

If the lens holder 12 does not include the notch 20 serving as the discontinuous portion, the Nyquist diagram changes as indicated by a broken line and point Q2 comes close to −1 and substantially reaches a limit of stability.

The Nyquist diagram of FIG. 8 proves that the provision of the objective lens 11 at the end 12a of the lens holder 12 is disadvantageous particularly in the tertiary vibration mode, not in the secondary vibration mode of higher vibration modes. In the present invention, the disadvantageous influence of the tertiary vibration mode is avoided by the notch 20 provided on the lens holder 12.

The optimum position of the notch 20 serving as the discontinuous portion is preferably determined by a search through a vibration analysis using computer analysis software and so on. The notch 20 is preferably disposed between the optical axis P of the objective lens 11 and the end 12a of the lens holder 12, thereby avoiding the influence of the tertiary vibration mode.

The design of the lens holder is equivalent to the frequency shaping of a transfer function from a driving point in a high frequency domain to the position of the objective lens 11, the frequency shaping using stiffness such as the geometrical moment of inertia of the lens holder 12 as a parameter.

When the driving point is displaced on the positions of the coils (the focusing coils 16A and 16B and the tracking coils 15) provided on the lens holder 12, the same effect can be obtained also by finely adjusting the position of the objective lens 11 to a point where the influence of a disadvantageous higher order vibration mode can be avoided.

The objective lens 11 and the lens holder 12 preferably are fixed with an adhesive having stiffness sufficiently lower than the stiffness of the lens holder 12. To be specific, it is particularly preferable to use an adhesive having stiffness not higher than one-fifth of the stiffness of the lens holder 12. By using a soft adhesive, the vibration systems of the objective lens 11 and the lens holder 12 can be examined separately, thereby increasing design freedom when the position of the discontinuous portion such as the notch 20 is determined.

In the foregoing embodiment, stiffness in parallel with the focusing direction is made discontinuous by forming the notch 20 as the discontinuous portion to obtain a discontinuous thickness in the focusing direction. The present invention is not limited to this configuration. On the rib 21 and so on, a thickness in the focusing direction and stiffness in the focusing direction may be made discontinuous by forming a thin portion in the thickness direction, a thin portion in the width direction, and a hole, a recessed portion, a slit, and so on. The discontinuous portion is effective when being formed on the rib 21 and the like for reinforcement but the present invention is not limited to this configuration. The discontinuous portion may be formed near a point where the objective lens 11 is mounted on the lens holder 12.

In the foregoing embodiment, the fixed part to which one end of each of the wires 13 is fixed is made up of the fixed base 26, the fixed substrate 27 or the like. The fixed part is not limited to this configuration as long as a part to be moved (moving part) and including the lens holder 12 and the objective lens 11 can be supported by the fixed part through the wires 13 so as to move relative to the fixed part. Further, the fixed part may be fixed to a portion fixed to a reference position for moving the moving part, for example, the base of the optical pickup device 7.

Moreover, in the foregoing embodiment, the magnets 14 are attached to the fixed part side and the tracking coils 15 and the focusing coils 16A and 16B are attached to the moving part side including the lens holder 12. The present invention is not limited to this configuration. The tracking coils 15 and the focusing coils 16A and 16B may be attached to the fixed part side and the magnets 14 may be attached to the moving part side including the lens holder 12.

The objective lens actuator of the present invention is suitable as an objective lens actuator used for the optical pickup device of an optical disk drive. Particularly, in an optical disk drive for recording/reproducing information at high speeds, it is possible to cause an objective lens stably to perform faster tracking in response to surface deflection and decentering which occur on a disk at high speeds.

What is claimed is:

1. An objective lens actuator comprising:
an objective lens for focusing a light beam on a disk;
a lens holder for holding the objective lens;
a fixed part;
a plurality of wires each having one end fixed to the fixed part and an other end fixed to the lens holder to support the lens holder with elasticity; and
a magnetic circuit having magnets and coils,
the magnetic circuit being configured such that the magnets are disposed on one of the fixed part and the lens holder and the coils are disposed on an other of the fixed part and the lens holder, and the magnetic circuit being able to drive the lens holder in a focusing direction and a tracking direction,
wherein the lens holder has an end on an extension line from a driving point for driving the lens holder to an optical axis of the objective lens, and
the lens holder includes a discontinuous portion on a side of the end on the lens holder relative to the optical axis of the objective lens, the discontinuous portion having discontinuous stiffness in parallel with the focusing direction.

2. The objective lens actuator according to claim 1, wherein the lens holder has an optical axis disposed at one of a node of a tertiary vibration mode of a vibration caused by a thrust force and a point near the node when the thrust force is applied at the driving point in the focusing direction.

3. The objective lens actuator according to claim 1, wherein the lens holder has a rib of discontinuous thickness in the focusing direction from the optical axis of the objective lens to the end and thus stiffness is made discontinuous in parallel with the focusing direction.

4. The objective lens actuator according to claim 1, wherein the lens holder has a rib of continuously changing thickness in the focusing direction from the optical axis of the objective lens to the end, the rib being cut partially at a point between the optical axis and the end, and thus stiffness is made discontinuous in parallel with the focusing direction.

5. The objective lens actuator according to claim 1, wherein the objective lens and the lens holder are fixed with a fixing agent having a stiffness sufficiently lower than the stiffness of the lens holder.
